(19) United States
(12) Patent Application Publication
(10) Pub. No.: US 2009/0026983 A1
(43) Pub. Date: Jan. 29, 2009

(54) Lighting Device and Display System with a Lighting Device

(75) Inventors: Christian Breuer, Newburyport, MA (US); Andreas Huber, Maisach (DE)

Correspondence Address: OSRAM SYLVANIA INC, 100 ENDICOTT STREET, DANVERS, MA, 01923, US

(73) Assignee: OSRAM GESELLSCHAFT MIT BESCHRANKTER HAFTUNG, MUNCHEN (DE)

(21) Appl. No.: 12/224,541

(22) PCT Filed: Feb. 28, 2007
(86) PCT No.: PCT/EP2007/051908

§ 371 Date: Aug. 29, 2008

(30) Foreign Application Priority Data
Mar. 3, 2006 (DE) 10 2006 009 975.3

(51) Int. Cl. H05B 37/00

(52) U.S. Cl. 315/312

(57) ABSTRACT

A lighting device (10, 11) has at least one light source (1, 1R, 1G, 1B) which is actuated by an operating unit (2) with an electrical signal on the basis of a light curve (3) stored in the operating unit (2). A display system having such a lighting device is also described.

The invention relates to a lighting device with at least one light source and to a display system with such a lighting device.

Display systems and their lighting devices are described, for example, in the documents U.S. Pat. No. 5,633,755 and U.S. Pat. No. 6,323,982. Display systems, such as DLP projectors (short for “digital light processing projectors”), for example, comprise a lighting device with a light source, whose light is directed at a DMD chip (short for “digital mirror device chip”). The DMD chip comprises microscopically small pivotable mirrors, which direct the light either at the projection area if the associated pixel is intended to be switched on, or direct the light away from the projection area, for example onto an absorber, if the associated pixel is intended to be switched off. Each mirror therefore acts as a light valve, which controls the luminous flux of a pixel. These light valves are referred to here as DMD light valves. For color generation, a DLP projector, in the case of a lighting device which emits white light, comprises a filter wheel, for example, which is arranged between the lighting device and the DMD chip and contains filters of various colors, for example red, green and blue. With the aid of the filter wheel, light of the respectively desired color from the white light of the lighting device is allowed to pass through sequentially.

The color temperature of such display systems is generally associated with the color locus of the light of the lighting device. This color locus generally changes with the operational parameters of the light sources of the lighting device, such as voltage, current intensity and temperature, for example. Furthermore, the ratio between the current intensity and the luminous flux is not necessarily linear, depending on the light sources used in the lighting device. In the event of a change in the current intensity, this likewise results in a change in the color locus of the light of the light source and therefore in a change in the color temperature of the display system.

Furthermore, the color depth of the display system is limited by the minimum switch-on duration of a pixel. In order to increase the color depth, dithering can be used, for example, in which individual pixels with a lower frequency than the regular frequency of 1/60 Hz are switched. However, this generally results in noise visible to the human eye.

The contrast ratio of the display system is defined by the ratio of the maximum luminous flux when the light valves are completely open to the minimum luminous flux when the light valves are completely closed. In order to increase the contrast ratio of a display system, for example, the minimum luminous flux when the light valves are completely closed can be further reduced by means of a mechanical mask. A mechanical mask takes up space in the lighting device or the display system, however, increases the weight of the lighting device or of the display system and also represents an additional potential source of faults.

An object of the invention is to specify a lighting device whose color locus can be matched in a targeted manner. A further object is to specify a display system with such a lighting device. Furthermore, it is desirable to specify a lighting device for use in a display system, with the aid of which the color depth and/or the contrast ratio of the display system can be improved in a simple manner.

These objects are achieved by a lighting device having the features of patent claim 1 and by a display system having the features of patent claim 15.

Preferred embodiments of the lighting device and of the display system are given in dependent claims 2 to 14 and 16 to 20, respectively.

A lighting device according to the invention comprises a control gear, which drives at least one light source with an electrical signal in accordance with a light curve stored in the control gear.

The term “light curve” should in this case be understood to mean a function of the illuminance over time. The control gear generates the electrical signal for driving the light source corresponding to the light curve, with the result that the light source generates the respectively desired illuminance.

The electrical signal used to drive the light source is preferably a current intensity signal.

The lighting device can preferably be used in a display system whose colors are driven sequentially. With the aid of the light curve, the luminous flux of the lighting source for each color can advantageously be varied in a targeted manner over time in such a way that, when using the lighting device in a display system with sequential color control, the luminous flux of the lighting device can be set separately for each color in a desired manner in such a way that the color temperature of the display system is matched to a desired value.

In a preferred embodiment of the lighting device, the light curve has segments with an illuminance which is constant over time. Particularly preferably, the light curve comprises segments with an illuminance which is constant over time. This means that, for a time tₓ, the light curve has an illuminance Bₓ which is constant over time and, in the subsequent time interval tₓ₊₁, an illuminance Bₓ₊₁ which is likewise constant over time. If the lighting device is used in a display system with sequential color control, a single color of the display system is preferably switched on during the time interval tₓ and a different color is switched on during the subsequent time interval tₓ₊₁.

When changing to the other color, the light curve also changes to a different illuminance which is constant over time if a different brightness of this color should be required for setting a specific color temperature. Thus, the light source is supplied with a corresponding electrical signal for each color in order to match the color temperature of the display system to a desired value.

The change between the illuminances of the individual segments can be achieved, for example, by varying the operating current and/or driving the light sources by means of a pulse-width-modulated signal (PWM signal). Varying the operating current is preferably used in the case of gas discharge lamps, while PWM signals are generally used for driving light-emitting diodes. A pulse-width-modulated signal, preferably a square-wave signal, signals the state “on” for a specific time tₒₙ within a fixed basic period and signals the state “off” for the rest of the duration of the basic period t_{off}. The ratio of the switch-on time to the basic period tₒₙ/(tₒₙ+t_{off}) is referred to as the duty factor. It indicates the percentage time component over which the square-wave signal is switched on within the basic period.

If the light curve contains short segments with a very low illuminance, given the same switch-on duration of the light valves the quantity of light emitted by the lighting device can be reduced thereby, as a result of which the color depth of the display system can advantageously be increased without, for example, visible noise being generated, such as in the case of the above-described dithering. The minimum duration which can have a short segment depends on the light valves used. In the case of DMD light valves, this minimum duration is preferably approximately 8 μs, and in the case of LCD light valves it is approximately 1 ms.

Here, “LCD light valve” is intended to mean a light valve which is realized by means of a liquid crystal matrix. The illuminance preferably has one of the following values during these short segments: 50%, 25%, 12.5%. Each time this value is halved, there generally results an additional bit of color depth.

Preferably, the light curve has a periodic signal whose period is between 16 ms and 20 ms, inclusive, or comprises such a signal. Periodic repetition with a period duration of between 16 ms and 20 ms provides the advantage that no flicker can be identified by the human eye.

In a further preferred embodiment of the lighting device, the control gear is suitable for the light curve to be altered in a targeted manner, for example by a user or by an external control signal, during operation. As a result, the color locus of the light of the lighting device can be matched, for example by varying the light curve, in such a way that the color temperature of the display system in which the lighting device is being used is matched to a desired application by a user or automatically.

Particularly preferably, the control gear scales the light curve proportionally with respect to a predetermined reference value. As a result, the average luminous flux of the lighting device can be lowered or else raised with the aid of the control gear, depending on which color locus of the lighting device is desired for the respective application. Particularly preferably, the scaling takes place in linear fashion. By means of lowering or raising the luminous flux by means of the light curve, the contrast ratio of the display system in which the lighting device is being used can advantageously be improved.

In a further preferred embodiment of the lighting device, the control gear detects operational parameters of the light source. Operational parameters of the light source are, for example, voltage, temperature, current intensity and color of the light. If, for example, the dependence of the spectrum of the light source on the operational parameters thereof is stored in the control gear, the control gear can advantageously regulate the electrical signal for driving the light source in such a way that changes in the spectrum of the light source on account of changed operational parameters are compensated for and therefore the color locus of the lighting device and the color temperature of the display system in which the lighting device is being used is kept constant. Furthermore, in this way nonlinearities in the illuminance/current intensity characteristic can be compensated for dynamically.

In a particularly preferred embodiment, the control gear keeps the luminous flux of the light source constant by means of a control loop comprising the operational parameters of the light source and the predetermined reference value. As a result, the color locus of the lighting device can advantageously be kept constant.

Furthermore, the control gear preferably alters the reference value in a targeted manner during operation, for example on the basis of the inputting of corresponding values by a human user. Thus, the color locus of the lighting device can advantageously be altered during operation by a user in a desired manner.

In a further preferred embodiment of the lighting device, the current intensity/illuminance characteristic of the light source is stored in the control gear. This makes it possible for the control gear to regulate the electrical signal for driving the light source in such a way that the luminous flux of the light source is kept constant. Furthermore, it is thus possible to maintain the relative relationships between the illuminance of individual segments despite a nonlinear current intensity/illuminance characteristic. If the lighting device comprises a plurality of light sources, either one current intensity/illuminance characteristic can be stored in the control gear if the light sources all have the same current intensity/illuminance characteristic, or a plurality of current intensity/illuminance characteristics can be stored in the control gear if the light sources have different current intensity/illuminance characteristics. The latter is generally the case if light sources of different colors are used in the lighting device.

In a further embodiment of the lighting device, the latter comprises one or more light sources, which emit light with a color locus in the white region of the CIE standard chromaticity diagram. Such a lighting device is particularly suitable for use in a display system whose colors are generated sequentially by means of a color modulator, such as a filter wheel.

In a further embodiment of the lighting device, the latter comprises at least two light sources, which emit light of different colors. Such a lighting device can be used in particular in a display system which does not have a color modulator. In this embodiment, the colors are generated directly by the light sources, which are driven sequentially one after the other in accordance with the light curve by an electrical signal. In an expedient configuration, in this case the light curve has segments with a constant illuminance in each case during the time intervals in which the individual colors are switched on. In this way, the brightness of each color is set in accordance with the illuminance of the respective light curve segment and thus the color locus of the lighting device is set to a desired value.

Particularly preferably, the lighting device comprises one red, one green and one blue light source. Such a lighting device can generate red, green and blue light sequentially one after the other with the aid of the light curve in such a way that a white color impression is imparted on the human eye.

Gas discharge lamps, semiconductor light-emitting diodes, organic light-emitting diodes or laser diodes are used, for example, as the light sources in the lighting device.

The lighting device is particularly suitable for use in a display system. The display system is preferably a DLP projector. Furthermore, the lighting device can also be used, for example, in an LCD display, in which the light valves are generated by means of a liquid crystal matrix. The colors can be generated in an LCD display either directly by means of backlighting or by means of a filter plate. If the colors are intended to be generated directly by means of backlighting, a suitable lighting device is, for example, one which has at least two light sources of different colors, as described above.

Furthermore, the lighting device is particularly suitable for use with a display system whose colors are driven sequentially.

In a preferred embodiment of the display system, the light curve is matched to the display contents to be represented via a communications interface (in particular the power/mean illuminance). This provides the advantage that, for example, the illuminance of the light source(s) can be matched dynamically to the brightness of the display contents. As a result, both contrast and color depth can be improved.

In a further preferred embodiment of the display system, the control gear matches the light curve to the speed of the synchronization signal by means of temporal scaling. The synchronization signal generally has a frequency of 50 Hz or 60 Hz and therefore corresponds to the frequency of a video signal. The synchronization takes place in such a way that all of the segments of the light curve are scaled linearly until a full period of the light curve matches a full period of the synchronization signal. Then, the phase relationship between the two signals is also set to a fixed value. The light curve then generally has a duration of 16.67 ms or 20 ms. If a filter wheel is used, the filter wheel runs through all of the colors between one and eight times in this time. The light curve therefore generally contains a plurality of color filter periods.

In a further preferred embodiment of the display system, the synchronization signal is connected to a sequential color modulator. A sequential color modulator is intended to mean an apparatus which selects different colors one after the other, i.e. sequentially, from light with a color locus in the white region of the CIE standard chromaticity diagram. A color modulator may be, for example, a filter wheel.

In an embodiment of the display system, a plurality of light curves are stored in the control gear, which light curves can be selected by the control gear depending on the synchronization signal in order to output corresponding electrical signals for driving the light sources. In this way it is possible to match the color temperature of the display system by means of the selection of the light curve.

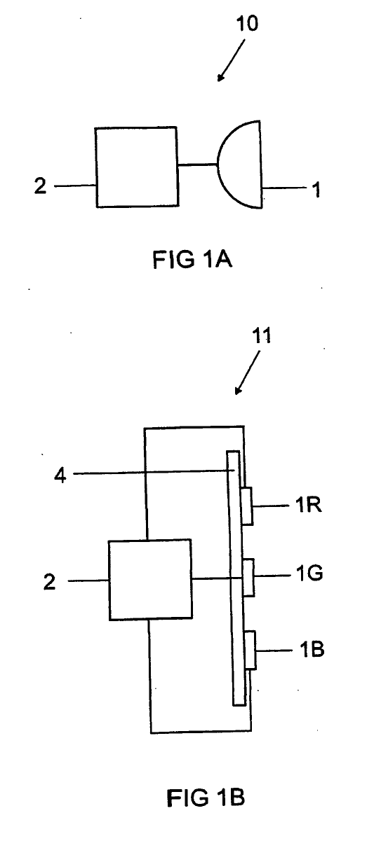

Further advantages, embodiments and preferred developments of the invention are given in the exemplary embodiments described in the text which follows in conjunction with FIGS. 1A to 5, in which:

FIGS. 1A and 1B show schematic illustrations of two exemplary embodiments of the lighting device,

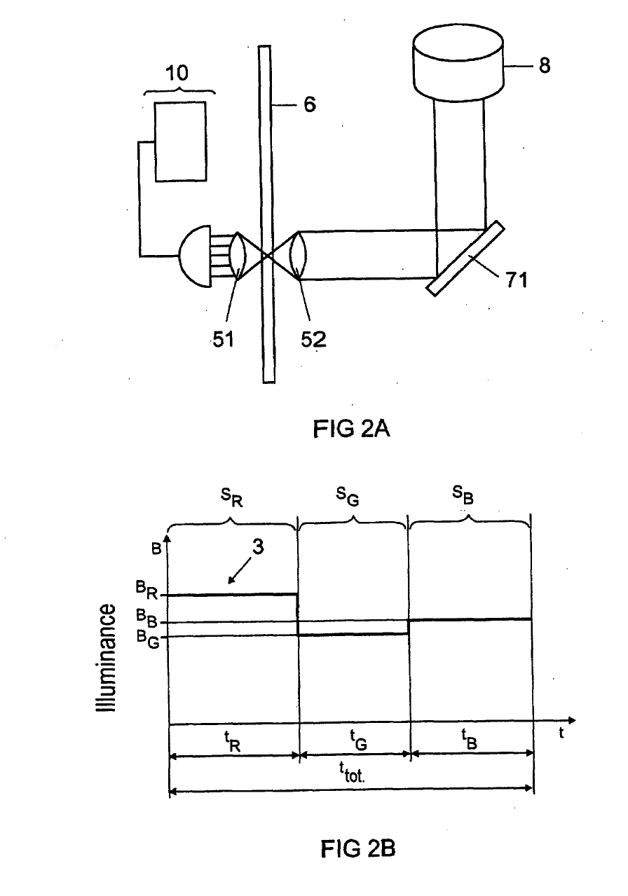

FIG. 2A shows a schematic sectional illustration of a first exemplary embodiment of a display system,

FIG. 2B shows a schematic graph of a light curve which is used in the first exemplary embodiment of the display system,

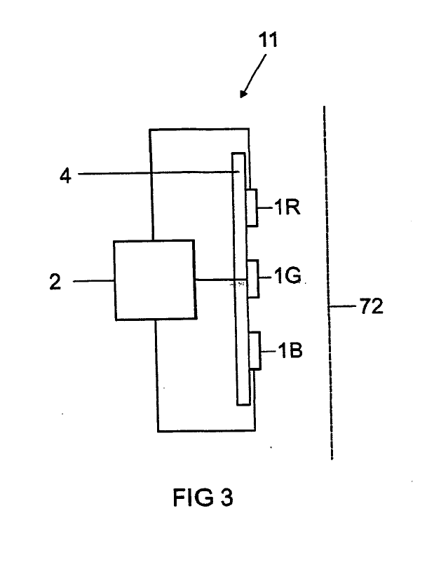

FIG. 3 shows a schematic sectional illustration of a second exemplary embodiment of a display system,

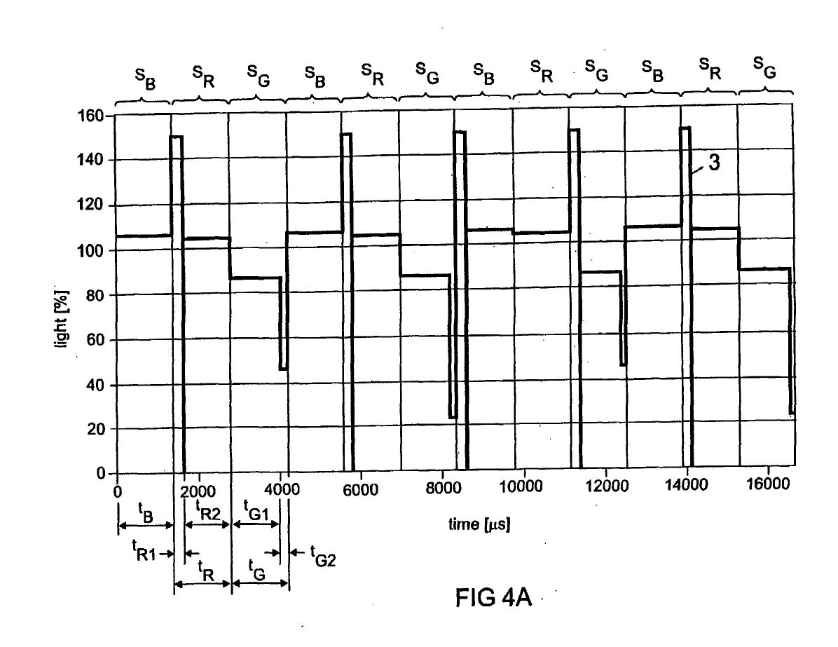

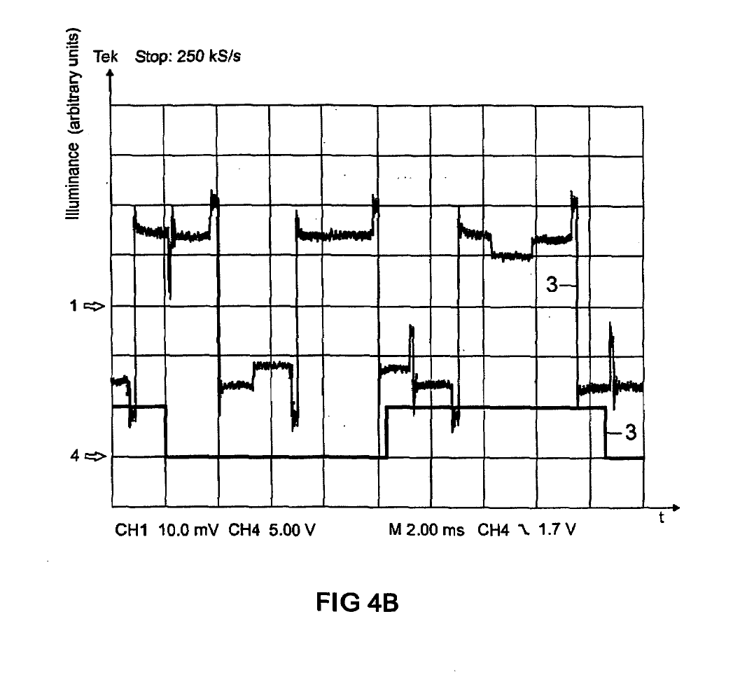

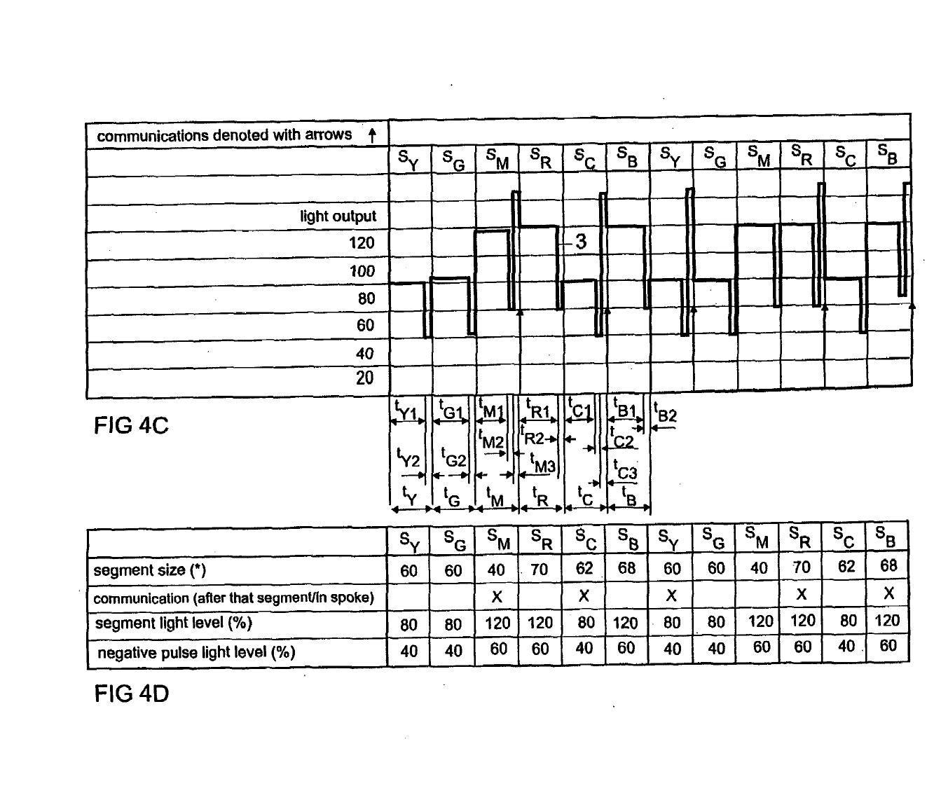

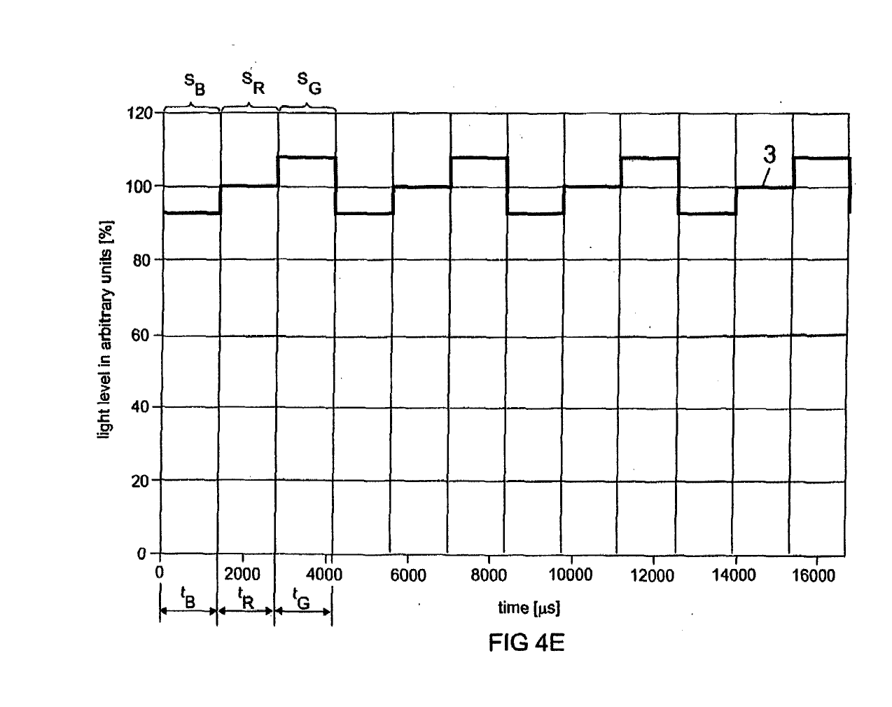

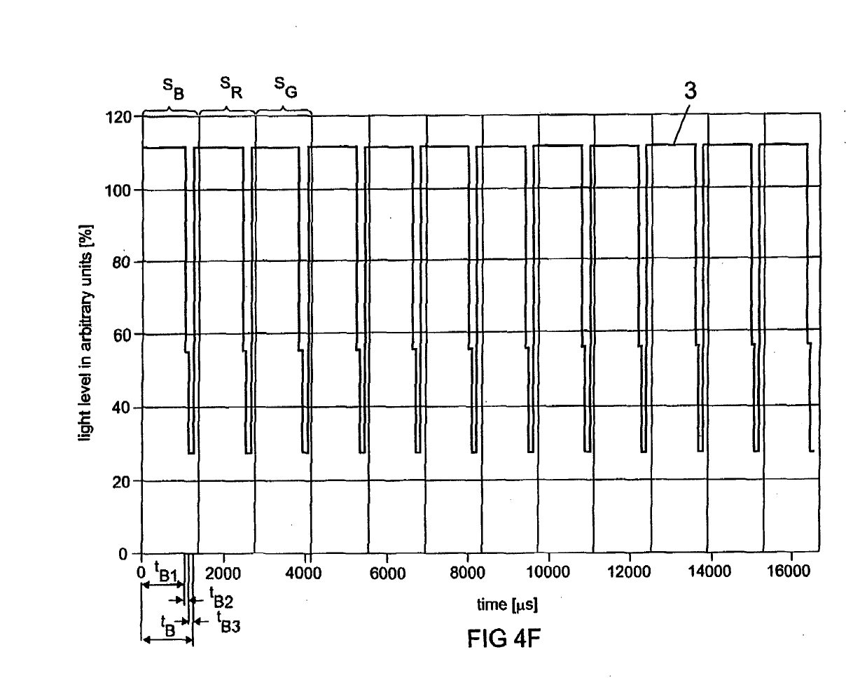

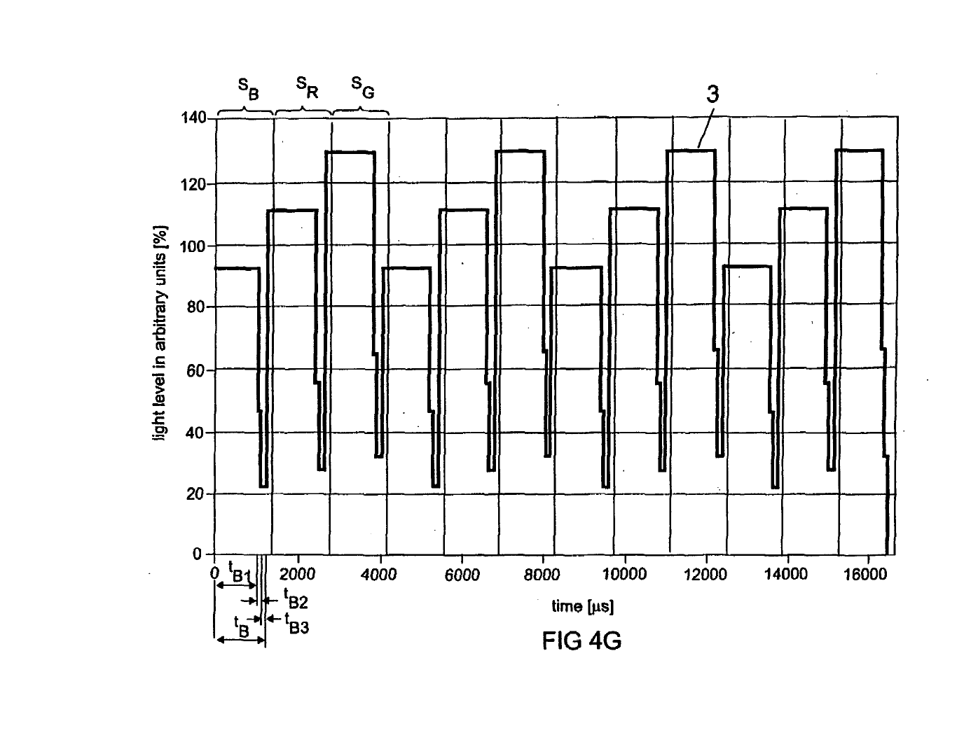

FIGS. 4A to 4C show schematic graphs of three exemplary light curves for operating a lighting device in accordance with the invention,

FIG. 4D shows an illustration in table form of the light curve from FIG. 4C,

FIGS. 4E to 4G show schematic graphs of three further exemplary light curves for the exemplary explanation of the structure of a light curve, and

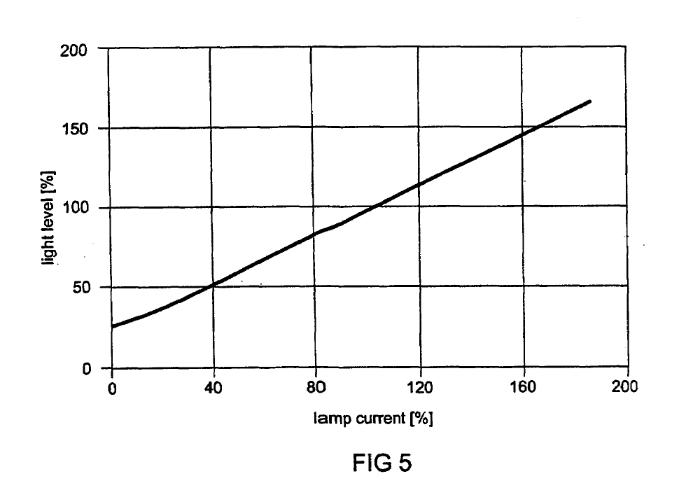

FIG. 5 shows a schematic graph of an exemplary current intensity/illuminance characteristic of a light source for operating a lighting device in accordance with the invention.

In the exemplary embodiments and figures, identical or functionally identical components have each been provided with the same reference symbols. The elements illustrated should in principle not be considered as being true to scale. Instead, individual elements, such as light sources for example, can be given oversized proportions for better understanding.

The lighting device 10 in accordance with the exemplary embodiment in FIG. 1A comprises a light source 1, in this case a gas discharge lamp, which emits light with a color locus in the white region of the CIE standard chromaticity diagram. The gas discharge lamp 1 is a point light source with a very small arc gap, which has a high energy density of approximately 300 W/mm³.

Alternatively, the use of, for example, organic light-emitting diodes (OLEDs), semiconductor light-emitting diodes (LEDs) or laser diodes (LDs) is possible.

Furthermore, the lighting device 10 shown in FIG. 1A comprises a control gear 2, such as a function generator, for example, which can provide electrical signals with a power of 300 W. The control gear 2 drives the light source 1 with an electrical current intensity signal, which follows a light curve 3. Light curves 3 will be explained in more detail later in connection with FIGS. 2A and 4A to 4C.

The lighting device 11 shown in FIG. 1B comprises a control gear 2 such as that of the lighting device 10 shown in FIG. 1A, with the difference that the lighting device 11 comprises three light sources 1, which emit light of different colors. In this case, the light sources are an LED which emits red light (referred to below as “red LED” for short), an LED which emits green light (referred to below as “green LED” for short) and an LED which emits blue light (referred to below as “blue LED” for short). The red LED is identified in the figures by the reference symbol 1R, the green LED by the reference symbol 1G and the blue LED by the reference symbol 1B.

As in the case of the lighting device 10 shown in FIG. 1A, the control gear 2 drives the light sources 1R, 1G, 1B of the lighting device 11 with an electrical signal which corresponds to a light curve 3. The LEDs 1R, 1G, 1B are mounted on a carrier 4, for example a metal-core printed circuit board, and electrically conductively connected to the control gear 2. As in the control gear 2 of the lighting device 10 shown in FIG. 1A, a light curve 3 is stored in the control gear 2 of the lighting device 11 shown in FIG. 1B, in accordance with which light curve 3 electrical signals are generated by the control gear 2 for driving the LEDs 1R, 1G, 1B.

The display system shown in FIG. 2A comprises a lighting device 10 in accordance with the exemplary embodiment in FIG. 1A. This lighting device 10 emits white light which is focused onto colored filters of a filter wheel 6 by means of an optical element 51, for example a lens. A further optical element 52, for example likewise a lens, is arranged downstream of the filter wheel 6 in the emission direction of the lighting device 10 and directs the light selected by the filter wheel 6 onto a DMD chip 71.

The DMD chip 71 comprises, as already described in the introductory part of the description, microscopically small pivotable mirrors, which direct the colored light either onto a projection optical element 8 or away from it, depending on whether the associated pixel is intended to be switched off or not. In other words, the DMD chip 71 comprises the light valves for controlling the individual pixels of the display system. The filter wheel 6 in this case acts as a color modulator, which selects individual colors from the white light of the lighting device 10 sequentially one after the other. In the present exemplary embodiment, the filter wheel 6 contains a red filter, a green filter and a blue filter. An alternative filter wheel 6 with other colors is described further below in connection with FIG. 4C.

The light curve 3 in FIG. 2B stored in the control gear 2 of the display system shown in FIG. 2A in this case comprises three segments S_{R}, S_{G}, S_{B}, which are assigned to the individual colors of the filters of the filter wheel 6, red, green and blue. The first segment S_{R} has a time interval t_{R}, while the light curve 3 has a constant illuminance BR. The first segment S_{R} is assigned to the color red, i.e., during the time interval t_{R}, the red filter of the filter wheel 6 selects red light from the white light of the lighting device 10. After the time interval t_{R}, the illuminance of the light curve changes to the illuminance B_{G}, which is kept constant during a time interval t_{G} of the second segment S_{G} which is assigned to the color green. Therefore, during the time interval t_{G}, the green filter of the filter wheel 6 selects green light from the white light of the lighting device 10. Once the time interval t_{G} has elapsed, the filter wheel 6 changes to the blue filter and the light curve 3 changes to the third segment S_{B}. This means that the illuminance of the light curve 3 changes to the value B_{B}, which is kept constant during a time interval t_{B}. As a result of the different values for the illuminance within the various segments S_{R}, S_{G}, S_{B} of the light curve 3 which are assigned to the individual colors red, green and blue of the filters of the filter wheel 6, the illuminance of the lighting device 10 is matched in such a way that the brightnesses of the individual colors red, green and blue correspond to a desired value and result in a predetermined color temperature of the display system. The three segments S_{R}, S_{G}, S_{B} of the light curve 3 form a period of the light curve 3 which has a duration of between 16 ms and 20 ms, inclusive.

The display system of the exemplary embodiment shown in FIG. 3 comprises a lighting device 11 as shown in FIG. 1B. Furthermore, the display system shown in FIG. 3 does not comprise a sequential color modulator 6, such as a filter wheel, for example, as the display system shown in FIG. 2A does. The individual pixels of the display system shown in FIG. 3 are not switched on and off by means of a DMD chip 71, but by means of a liquid crystal matrix 72. This liquid crystal matrix 72 is arranged downstream of the lighting device 11 in its emission direction. For color generation, in this case the control gear 2 switches the individual light sources of various colors 1R, 1G, 1B of the lighting device on one after the other individually in accordance with a light curve 3 stored in the control gear 2 by means of an electrical signal. The above-described light curve 3 shown in FIG. 2B or a similar light curve 3 can be used, for example, as the light curve 3 and is used to drive the brightness of the individual light sources 1R, 1G, 1B of different colors in accordance with a predetermined color temperature of the display system.

The light curve 3 in the exemplary embodiment shown in FIG. 4A comprises a periodic sequence of in each case three segments S_{R}, S_{G}, S_{B}. The first segment S_{B} is assigned to the color blue, the second segment S_{R} to the color red and the third segment S_{G} to the color green. This light curve 3 can be stored in the control gear 2 of the lighting devices 10, 11 which are used in the display systems shown in FIGS. 2A and 3, for example as an alternative to the light curve 3 shown in FIG. 2B.

The first segment S_{B} of the light curve in FIG. 4A is assigned to the color blue and has a duration t_{B} of approximately 1300 μs. During this time interval t_{B}, the luminous flux of the lighting device 10, 11 is approximately 120%.

After the first segment S_{B} there is a second segment S_{R}, which is assigned to the color red and has a duration of t_{R}. During a first time interval t_{R1} of the time interval t_{R}, the luminous flux of the lighting device 10, 11 is approximately 150% for a short period of time, while the luminous flux in a second time interval t_{R2}, which directly follows the first time interval t_{R1} and with it forms the time interval t_{R}, is approximately 120%. The time interval t_{R1} is in this case markedly shorter than the time interval t_{R2}. The time interval t_{R1} is in this case approximately 100 μs, while the time interval t_{R2} is in this case approximately 1200 μs.

After the second segment S_{R} there is a third segment S_{G}, which is assigned to the color green and has a duration t_{G} of likewise approximately 1300 μs. The time interval t_{G} is also split into two time intervals t_{G1} and t_{G2} as is the time interval t_{R}, the first time interval t_{G1} being markedly longer than the second time interval t_{G2}. The first time interval t_{G1} is in this case approximately 1200 μs, while the second time interval t_{G2} of the green segment has a duration of approximately 100 μs. During the first time interval t_{G1}, the light curve 3 has a constant value of approximately 85%, which is lowered to a value of approximately 45% for the time interval t_{G2} for a short period of time.

Once these three segments S_{R}, S_{G}, S_{B} have elapsed, a substantially periodic repetition of these three segments S_{R}, S_{G}, S_{B} takes place, with the arrangement of the short time intervals t_{R1}, t_{G2} within the segments in which the luminous flux is markedly raised or lowered in comparison with the rest of the segment S_{R}, S_{G} deviating from the periodicity. The short time intervals of the light curve 3 in which the illuminance is lowered to a great extent are used for increasing the color depth, as has already been described in the general part of the description. The short segments within which the illuminances are raised to a great extent are provided for stabilizing the electrodes of gas discharge lamps if such lamps are used as the light sources 1. If other light sources 1, for example LEDs, are used, such short raised segments within the light curve 3 are not necessary.

FIG. 4B shows two light curves 3. The graphs represent the illuminance and the color as a function of time. They each contain a full period of the light curve form, in general with a duration of between 16 and 20 ms. In the case of white light sources, the colors are generated by color filters, and in the case of a plurality of colored light sources, for example LEDs, the control gear 2 switches between the colors.

The light curve of the exemplary embodiment shown in FIG. 4C is designed for a filter wheel 6 with six different filters with the colors yellow, green, magenta, red, cyan and blue. Correspondingly, the light curve 3 comprises a periodic sequence of six different segments S_{Y}, S_{G}, S_{M}, S_{R}, S_{C}, S_{B}, which are assigned to the respective color. The segments S_{Y}, S_{G}, S_{M}, S_{R}, S_{C}, S_{B} are designated below by the color to which they are assigned. Each segment S_{Y}, S_{G}, S_{M}, S_{R}, S_{C}, S_{B} of the light curve 3 has in this case a constant value of the luminous flux over the majority of the duration of the respective segment.

Time intervals t_{Y}, t_{G}, t_{M}, t_{R}, t_{C}, t_{B} are again assigned to the individual segments S_{Y}, S_{G}, S_{M}, S_{R}, S_{C}, S_{B}, which time intervals t_{Y}, t_{G}, t_{M}, t_{R}, t_{C}, t_{B} are split into two or three time intervals t_{Y1}, t_{Y2}, t_{G1}, t_{G2}, t_{M1}, t_{M2}, t_{M3}, t_{R1}, t_{R2}, t_{C1}, t_{C2}, t_{C3}, t_{B1}, t_{B2}, with in each case one of the time intervals being markedly longer than the others. These time intervals are referred to below as “long time intervals”. The values of the luminous fluxes in the long time intervals of the individual segments are given in the table in FIG. 4D in the row entitled “segment light level”. The yellow and the green segment S_{Y}, S_{G} have a constant luminous flux of 80% during the long time interval. The magenta and the red segment S_{M}, S_{R} have a luminous flux of 120% during the long time interval, while the cyan segment S_{C} has a luminous flux of 80% during the long time interval and the blue segment S_{B} has a luminous flux of 120% during the long time interval. At the end of any segment, there is a short time during which the light level is lowered to a greater extent in comparison with the long time interval. These values are given in the table in FIG. 4D in the row entitled “negative pulse light level”. The luminous flux is lowered to a value of 40% in the case of the yellow and the green segment S_{Y}, S_{G}, to a value of 60% in the case of the magenta and the red segment S_{M}, S_{R}, to a value of 40% in the case of the cyan segment S_{C}, and to a value of 60% in the case of the blue segment S_{B}. Furthermore, at the end of the magenta segment S_{M} and at the end of the cyan segment S_{C} there is a communication which is symbolized by arrows and is in each case linked to a luminous flux which is raised in comparison with the long time interval.

The segment sizes of the different colors are not identical, as can be seen from the table in FIG. 4D in the row entitled “segment size”, but have a value of 60° in the case of the yellow and the green segment S_{Y}, S_{G}, a value of 40° in the case of the magenta segment S_{M}, a value of 70° in the case of the red segment S_{R}, a value of 62° in the case of the cyan segment S_{C} and a value of 68° in the case of the blue segment S_{B}. These values are matched to the light curve 3.

In combination with a light curve 3 whose segments S_{R}, S_{G}, S_{B} are assigned to the colors red, green and blue, as shown, for example, in FIGS. 2B and 4A, a filter wheel 6 with two red, two blue and two green filters is generally used. The filters are in this case preferably arranged in the sequence red, green, blue, red, green, blue. The sizes of the individual color filter segments may in this case be identical (60° for all six filters) or different, matched to the light curve 3 used.

The functions of the individual time intervals within the segments S_{R}, S_{G}, S_{B} will be explained in more detail by way of example below with reference to FIGS. 4E, 4F and 4G.

The light curve 3 shown in FIG. 4E comprises, as does the light curve 3 shown in FIG. 4A, a periodic sequence of a segment S_{B}, which is assigned to the color blue, of a segment S_{R}, which is assigned to the color red, and of a segment S_{G}, which is assigned to the color green. Each segment S_{R}, S_{G}, S_{B} has a duration of approximately 1500 μs. The time interval t_{B}, the time interval t_{R} and the time interval t_{G}, which are assigned to the respective segments S_{R}, S_{G}, S_{B}, therefore have identical lengths. Within a segment S_{R}, S_{G}, S_{B}, the light curves 3 have in each case one constant value. The light curve 3 has a value of approximately 95% during the time interval t_{B}, a value of approximately 100% during the time interval t_{R} and a value of approximately 110% during the time interval t_{G}. By means of the different levels of the light curve 3, the luminous flux of the lighting device is matched in such a way that a display system with this lighting device has a desired color temperature.

The light curve 3 shown in FIG. 4F shows, by way of example, short time intervals t_{B2}, t_{B3}, t_{R2}, t_{G1}, t_{G2}, t_{G3} at the end of each segment S_{R}, S_{G}, S_{B}, in a similar manner to as have been described above in connection with FIG. 4A. The light curve 3 in turn comprises a periodic sequence of a segment S_{B}, which is assigned to the color blue, a segment S_{R}, which is assigned to the color red and a segment S_{G}, which is assigned to the color green. The time interval t_{B}, t_{R}, t_{G} of each segment is split in this case into three time intervals of a long time interval t_{1B}, t_{1R}, t_{1G} at the beginning of each segment S_{R}, S_{G}, S_{B} and two short time intervals t_{B2}, t_{B3}, t_{R2}, t_{G1}, t_{G2}, t_{G3} in each case at the end of each segment S_{R}, S_{G}, S_{B}. During the short time intervals t_{B2}, t_{B3}, t_{R2}, t_{G1}, t_{G2}, t_{G3}, the luminous flux of the light curve 3 is lowered stepwise. The segment S_{B}, which is assigned to the color blue, is described here by way of example. During the time interval t_{B1}, the light curve 3 has a value of approximately 110%. In the time interval t_{B2}, which directly follows the time interval t_{B1}, the light curve 3 has a value of approximately 55%, while the value of the light curve 3 in the time interval t_{B3} following the time interval t_{B2} is lowered to approximately 30%. The time interval t_{B1} has a duration of approximately 1300 μs, while the time intervals t_{B2} and t_{B3} each have a duration of approximately 10 μs. The remaining segments S_{R}, S_{G} of the light curve have an identical design to the segment S_{B}, which is assigned to the color blue. The lowering of the light curve 3 during the short time intervals t_{B2}, t_{B3}, t_{R2}, t_{G1}, t_{G2}, t_{G3} serves the purpose of improving the color depth of the display system in which the lighting device is being used. The light curve 3 shown in FIG. 4G shows the two light curve forms already explained with reference to FIGS. 4E and 4F together in a light curve 3, in a way in which they can also be used in a lighting device. The description relating to the short segments t_{B2}, t_{B3}, t_{R2}, t_{G1}, t_{G2}, t_{G3} at the end of each segment S_{R}, S_{G}, S_{B} in FIG. 4F is in this case also valid for the short time intervals t_{B2}, t_{B3}, t_{R2}, t_{G1}, t_{G2}, t_{G3} in FIG. 4G, while the levels of the light curve 3 during the long time intervals t_{B1}, t_{R2}, t_{G3} of each segment S_{R}, S_{G}, S_{B} correspond to the value in accordance with the light curve 3 in FIG. 4E.

The current intensity/illuminance characteristic of the exemplary embodiment shown in FIG. 5 is approximately linear. It indicates a current intensity as a percentage on the x axis and a light level as a percentage on the y axis.

By means of the current intensity/illuminance characteristic, which can likewise be stored in the control gear 2 of the lighting device 10, 11, it is possible for the brightness of the light source 1, 1R, 1G, 1B of the lighting device 10, 11 to be kept to the illuminance predetermined by the light curve 3 in the case of altered lamp operational parameters, such as the current intensity, for example.

The invention is not restricted by the description with reference to the exemplary embodiments. Instead, the invention includes any novel feature and any combination of features, which in particular includes any combination of features in the patent claims, even if this feature or this combination itself is not explicitly specified in the patent claims or exemplary embodiments.

1. A lighting device (10, 11) with at least one light source (1, 1R, 1G, 1B), which is driven by a control gear (2) with an electrical signal in accordance with a light curve (3) stored in the control gear (2).

2. The lighting device (10, 11) as claimed in claim 1, in which the light curve (3) is a function of the illuminance (B) over time (t).

3. The lighting device (10, 11) as claimed in claim 2, in which the light curve (3) has segments (S) with an illuminance (B) which is constant over time.

4. The lighting device (10, 11) as claimed in claim 1, in which the light curve (3) has a periodic signal, whose period is between 16 ms and 20 ms, inclusive.

5. The lighting device (10, 11) as claimed in claim 1, in which the control gear (2) alters the light curve (3) in a targeted manner during operation.

6. The lighting device (10, 11) as claimed in claim 1, in which the control gear (2) scales the light curve (3) proportionally with respect to a predetermined reference value.

7. The lighting device (10, 11) as claimed in claim 1, in which the control gear (2) detects operational parameters of the light source (1, 1R, 1G, 1B).

8. The lighting device (10, 11) as claimed in claim 7 with reference to claim 6, in which the control gear (2) keeps the luminous flux of the light source (1, 1R, 1G, 1B) constant by means of a control loop comprising the operational parameters of the light source (1, 1R, 1G, 1B) and the predetermined reference value.

9. The lighting device (10, 11) as claimed in claim 6, in which the control gear (2) alters the reference value in a targeted manner during operation.

10. The lighting device (10, 11) as claimed in claim 1, in which the current intensity/illuminance characteristic of the light source (1, 1R, 1G, 1B) is stored in the control gear (2).

11. The lighting device (10, 11) as claimed in claim 1, in which the light source (1, 1R, 1G, 1B) emits light with a color locus in the white region of the CIE standard chromaticity diagram.

12. The lighting device (10, 11) as claimed in claim 1, which comprises at least two light sources (1, 1R, 1G, 1B), which emit light of different colors.

13. The lighting device (10, 11) as claimed in claim 12, which comprises at least one red, one green and one blue light source (1, 1R, 1G, 1B).

14. The lighting device (10, 11) as claimed in claim 1, in which gas discharge lamps, semiconductor light-emitting diodes, organic light-emitting diodes or laser diodes are used as the light sources (1, 1R, 1G, 1B).

15. A display system with a lighting device (10, 11) as claimed in claim 1.

16. The display system as claimed in claim 15, whose colors are driven sequentially.

17. The display system as claimed in claim 15, in which the light curve (3) is matched to the display contents to be represented via a communications interface.

18. The display system as claimed in claim 17, in which the control gear (2) matches the light curve (3) to the speed of the synchronization signal by means of temporal scaling.

19. The display system as claimed in claim 17, in which the synchronization signal is connected to a sequential color modulator (6).

20. The display system as claimed in claim 17, in which a plurality of light curves (3) are stored in the control gear (2), which light curves (3) are selected by the control gear (2) depending on the synchronization signal in order to modulate the electrical signal for driving the light source (1, 1R, 1G, 1B).
